(19) United States
(12) Patent Application Publication
(10) Pub. No.: US 2003/0083933 A1
(43) Pub. Date: May 1, 2003

(54) Systems and methods for providing rewards benefits to account holders

(76) Inventor: James A. McAlear, Stittsville (CA)

Correspondence Address: Adams Cassan Maclean, Suite 401, 80 Aberdeen St., Ottawa, ON, K1S 5R5, CA

(21) Appl. No.: 09/984,104

(22) Filed: Oct. 29, 2001

(51) Int. Cl. G06F 17/60

(52) U.S. Cl. 705/14

(57) ABSTRACT

Methods are provided for establishing rewards benefits for account holders to attract usage of such accounts. According to a first such method, data storage space is provided to an account holder, the storage space being accessible over the Internet through a central server running on-line digital assistant (ODA) system software configured for managing data in relation to the storage space. An Internet address and passcode are allocated to the account holder, the address enabling Internet access to the central server and the passcode enabling access by the account holder to the storage space. Use of the ODA system software by the account holder, to store, access and process data in the storage space, is enabled upon submission of the passcode. According to a second such method a separate, independently operable subsidiary credit card account is associated with an account holder's main credit card account and a separate credit limit is assigned to the subsidiary account for purchase authorization purposes. For example, rewards points may be accumulated through usage of the main account (the points being redeemable for value) and the value of the accumulated points attributed to the subsidiary account, whereby the credit limit of the subsidiary account is determined by that value.

### FIELD OF INVENTION

This invention relates generally to the field of financial systems/methods and, more particularly, to financial account (e.g. credit card) holders' benefits systems and a methods for rewarding account holders and encouraging account usage.

### BACKGROUND OF THE INVENTION

To attract usage of certain financial accounts, such as credit cards, it has become popular for financial institutions to offer rewards to the users of such accounts. Such rewards systems are adopted to persuade users to become holders of such accounts (i.e. to obtain credit cards with such financial institution) and, also, to encourage such account holders to maximize their usage of such accounts. For example, in some cases rewards points are earned by a credit card holder each time their credit card is used, the amount of the points earned being based on the amount of the purchased item which is charged to the account, and the accumulated points are convertible to items of value. For example, some rewards systems provide airline travel in exchange for accumulated points, some allow accumulated points to be used as cash towards the purchase of a car and others allow the account holder to redeem accumulated points to obtain merchandise. With the phenomenal growth of Internet usage in recent years, it becomes worthwhile to develop rewards systems specially targeted to such a large segment of society.

Current electronic commerce applications and security structures applied to Internet communications networks enable financial institutions to provide to their account holders' secure Internet access to their own account records. Such Internet access is facilitated by means of a Web browser using a PC or other device such as a mobile phone using a gateway to interface the mobile communications network to the Internet. The increasing popularity of Internet banking and Internet stock trading, for example, is indicative not only of the high level of security associated with such on-line banking or trading facilities (for which security is provided by HTTPS/SSL/TLS/PKI methods), but also of consumers' increased awareness of, and confidence in, such on-line facilities.

The use of portable, hand-held Personal Digital Assistants (PDAs) such as the products sold under the designation Palm Pilot™ (sometimes regarded as electronic wallet devices) are increasing in popularity to store personal information such as calendar, contacts and other data. Typically, these devices are set-up as accessories to a PC as they allow the data held within a user's PC to be downloaded to the device so that the user can travel with only the device in hand yet still have all their current calendar and contacts information. More recently, these devices have become equipped with wireless communications means enabling them to access the Internet and receive and send email messages (although these haven't yet approached the level of popularity of non-wireless enabled PDAs). In many cases consumers carry around both a PDA and a mobile phone because the former is able to provide access to a large amount of personal data on a secure basis while the latter is able to provide wireless voice communications. The need to have two such distinct devices increases costs for the consumer and introduces inconvenience. Moreover, PDA's are subject to failure in operation and loss of data because they are dependent upon a supply of battery power. Furthermore, they are subject to limitations imposed by memory and the data they hold may be lost through theft or damage. Moreover, there is no convenient means of electronically sharing data stored in a PDA with a third party's computer device (i.e. PC, PDA, mobile phone, etc.), especially a device that is not in physical proximity to the PDA.

Internet commerce is broadly available and used by consumers and such usage is currently dominated by relatively low cost purchases of information and entertainment products (books, music, games, software etc.). Children are attracted to such merchandise and, typically, are in a position where they would like to do so as they are frequent users of the Internet. However, due to security concerns, parents tend not to be willing to provide their credit card numbers to their children for purposes of purchasing such merchandise via the Internet.

Therefore, there is an opportunity in the marketplace for means to provide the functionality of a PDA on a centralized basis whereby personal information such as calendar and contacts information and data files may be stored and accessed from a central storage device which can be made both secure and reliable.

Further, there is an opportunity for such a centralized data storage means combined with means for allowing an account holder and authorized users to store data therein and access and modify stored data through the Internet using any suitable Internet access device including PC's, PDA's and mobile phones.

Recognizing that financial institutions have already expended valuable resources to provide secure on-line banking (or on-line stock purchase) facilities, there is a need for means to leverage the value and use of these facilities through the provision of a financial account rewards service which makes use of them. Advantageously, such a service would provide market and profit advantages over the known rewards systems.

In addition, it is not known for a financial institution to provide a facility for associating an existing financial account, such as credit card account, with a separate subsidiary account, usable by a designee of the credit card account holder, but for which a governing credit limit is established in such a manner as to avoid creating a security risk to the account holder (whose responsibility it is to ensure payment for any amounts owed in respect of such accounts) or negative effect on the account holders' own credit card usage. There is a need for such a facility to enhance the options available to consumers to purchase items via the Internet.

### SUMMARY OF THE INVENTION

A method for providing a rewards benefit to a holder of an account whereby data storage space in a data storage device is provided to the account holder, the storage space being accessed over the Internet and contained within a central server running online digital assistant (ODA) system software configured for managing data (e.g. electronic messages and files) in relation to the storage space. An Internet address and passcode are allocated to the account holder, the address enabling Internet access to the central server (i.e. via a Web browser running on an Internet access computer device such as a PC or mobile phone) and the passcode enabling access by the account holder to the storage space. The account holder is enabled to use the ODA system software to store, access and process data in the storage space upon submission of the passcode. This method may be performed by a financial institution, whereby the account is a credit card account, and preferably the data storage device is secured against access not authorized by the financial institution.

Preferably a temporary passcode is provided to the account holder in response to a request for the same by the account holder, the temporary passcode enabling a third party to use the ODA system software to access or store data in the storage space upon submission of the temporary passcode by the third party.

Preferably the ODA system software causes a main menu of selectable data management operations to be displayed on a display of an Internet access computer device used by the account holder to access the ODA system software following submission thereto of the account holder's passcode.

Also in accordance with this invention there is provided a computer network system operable through the Internet for providing such a rewards benefit to a holder of an account. A central server has an allocated Internet address. A data storage device comprising data storage space is configured for access over the Internet through the central server. On-line digital assistant (ODA) system software running on the central server is configured for: (i) allocating data storage space of the data storage device to the account holder, (ii) managing data in relation to the storage space; (iii) permitting access to the central server using an Internet access computer device upon submission of the Internet address therefor; and, (iv) enabling the account holder to store, access and process data in the storage space upon submission of a passcode allocated to the account holder.

A further method, and an account management and authorization software system operable on a computer processor, are provided for benefiting a holder of a credit card account having associated therewith a credit limit. According to this method a separate, independently operable subsidiary credit card account is associated with the credit card account and a subsidiary credit limit is assigned to the subsidiary account. An authorized designee of the credit card holder is enabled to effect charges against the subsidiary credit card account whereby the amount of the charges is limited by the subsidiary credit limit and any current balance of charges. Preferably, the subsidiary credit limit is assigned by the account holder.

A still further method of providing a rewards points benefit to a holder of an account, and an account management and authorization software system operable on a computer processor, are provided. Rewards points are accumulated through usage of the account and those points are redeemable for value. A separate, independently operable subsidiary account is associated with the account and the value of the accumulated points is attributed to the subsidiary account. Means are provided to enable a third party to use the value attributed to the subsidiary account through the subsidiary account. The method may be performed, and the system used, by a financial institution and the account may be a credit card account. Preferably the points are redeemable for cash so as to enable the third party (e.g. an authorized designee of the account holder) to purchase merchandise through the subsidiary account. Further, the value of the purchase by a third party through the subsidiary account is preferably limited to the value of a current balance of the attributed points which have not yet been redeemed.

### DESCRIPTION OF THE DRAWINGS

Preferred embodiments of the invention are described in detail below with reference to the following drawings in which like references pertain to like components throughout:

FIG. 1 is schematic block diagram showing the components of an Internet communications network with a financial institution's server used to provide an ODA rewards service in accordance with the invention and user access devices (handsets and PC's);

FIGS. 2(a)-(d) illustrate a mobile phone display during operation of an ODA in accordance with the invention, the displayed main menu (a) being selectable as shown from “files”, to the file “FordSvcRec.txt” (b) therein, to the command menu options (c) provided for that file in which “offer” is selected and then to the provision of a time-limited sharing passcode by which collaboration across the Internet is enabled (d);

FIGS. 3(a)-(d) illustrate a mobile phone display during operation of an ODA in accordance with the invention, the displayed main menu (a) being selectable as shown from “mail”, to the Inbox message “Jane Smith” (b) therein, to a character-limited display of the content of that selected message (c) and then to the auto-reply menu item (d) selected for that message;

FIG. 4 is a set of tables listing software modules of the ODA system which run on the financial institution's central server shown in FIG. 1;

FIG. 5 is a flow chart for a login software module of an on-line digital assistant (ODA) according to the invention;

FIG. 6 is a flow chart for a user account software module of an on-line digital assistant (ODA) according to the invention;

FIG. 7 is a flow chart for a main menu software module of an on-line digital assistant (ODA) according to the invention;

FIG. 8 is a flow chart for a “notes” software module of an on-line digital assistant (ODA) according to the invention (“notes” being one item of the main menu, and the remaining items of the main menu have similar software modules);

FIGS. 9(a)-(d) illustrate the script structure of the HTML, WML or HDML code of the ODA system. FIG. 9(a) shows a display of menu items under the “notes” main menu item and the command options menu available for the “note” menu and FIG. 9(b) shows their associated URL queries. FIG. 9(c) shows a display of the text of the “notes” menu item “soup recipe” and the command options menu available for this selected item and FIG. 9(d) shows their associated URL queries;

FIGS. 10(a), 10(b) and 10(c) are successive parts of a flow chart for “guest” software module of an on-line digital assistant (ODA) according to the invention;

FIGS. 11(a) and 11(b) illustrate a credit card authorization system and method according to another aspect of the invention whereby an account holder's credit card account is associated with a separate subsidiary card account the credit limit for which is controlled by the account holder (and is no greater than the credit limit of the account holder's credit card account). FIG. 11(a) illustrates a database structure for associating the account holder's account number and the subsidiary account number and accounting particulars relating to the credit limit governing each account. FIG. 11(b) is a flow chart of a purchase approval software module of the authorization system as applied to the subsidiary account (card); and,

FIGS. 12(a) and 12(b) illustrate an example of another aspect of the authorization system illustrated by FIGS. 11(a) and (b) whereby credit card points rewards, accumulated through usage of the credit card and redeemable for value, are attributed to a separate subsidiary card account and define a credit limit therefore. FIG. 11(a) illustrates a database structure for associating the account holder's account number and the subsidiary account number and accounting particulars relating to the accumulation and attribution of rewards points. FIG. 11(b) is a flow chart of a purchase approval software module of this authorization system as applied to the subsidiary account (card).

### DETAILED DESCRIPTION OF THE INVENTION

According to preferred embodiments of the applicant's invention a financial institution provides complementary, independent rewards to account holders, each of which utilize the Internet. Firstly, an On-line Digital Assistant (ODA) service is provided by a financial institution (e.g. a bank) to an account holder as a reward for holding an account, being a credit card in the illustrated preferred embodiment. The ODA service provides the account holder with an assigned amount of data storage within a centralized, secure server which forms part of the financial institution's on-line financial services facility (e.g. on-line banking) and software which runs on the account holder's Internet access computer device (e.g. a PC or mobile phone) enabling the account holder to address the data storage and store, access and process data on the server in like manner to a hand-held PDA (computer organizer such as a PalmPilot). Advantageously, the centralization of the account holder's data allows the account holder to access the data using a personal Internet URL address from any type of Internet access computer device and provides a high degree of security for that data. The single URL address for data associated with the account holder advantageously provides consistency for the account holder and, in turn, the third parties with whom the account holder wishes to share any ODA-stored data.

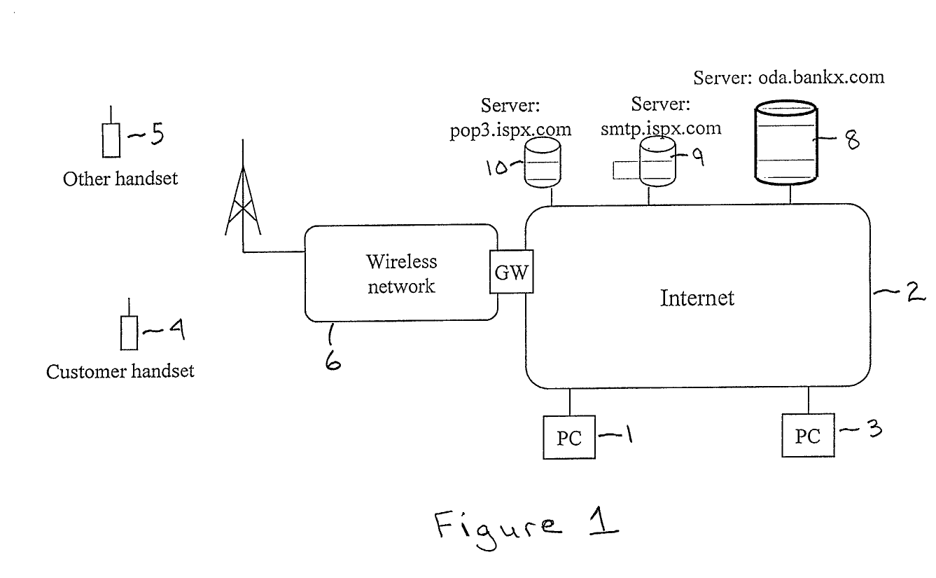

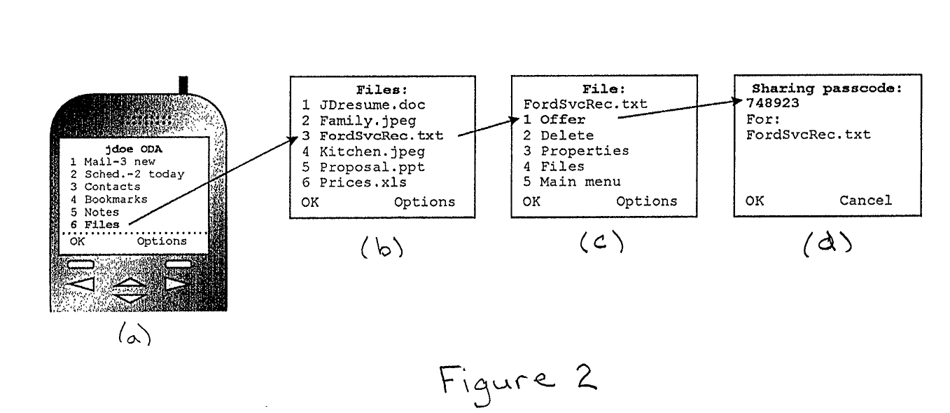

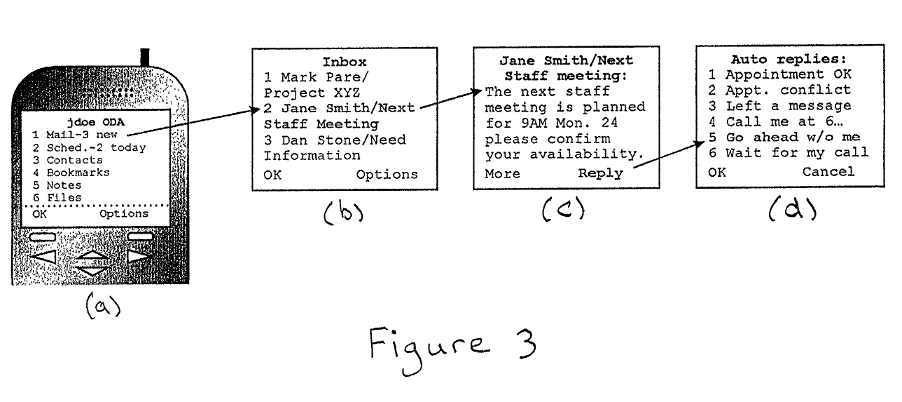

The ODA service is performed by ODA system software running on a conventional but secured central server 8 (see FIG. 1) which may also be used by the financial institution (e.g. bank or a credit card company) for its on-line financial services such as online banking services. As such, consumers may be expected to have a high degree of confidence in the security and integrity of the system. The ODA system software runs on commonly used operating systems including Windows and Unix variants (e.g. Linux). The ODA system software manages data and messages moving in and out of an account holder's assigned server storage, whereby each account holder is assigned separate storage space which is maintained by the ODA system software. The account holder is assigned a unique URL (e.g. oda.bankx.com/customer1) with which the account holder can enable links to third parties as and when desired to create a secure communications link for the sharing or exchange of information and messages (see FIGS. 2 and 3).

Secondly, a reward is provided where a financial account holder (e.g. a credit card customer) is permitted to set up a limited credit subsidiary account for use by a designated beneficiary (such as a child). In one form, the account holder allocates a specified credit limit to the subsidiary account. In another form cash-convertible points accumulated through use of the credit card are provided by a financial institution (e.g. a bank) to an account holder as a reward whereby the points are attributed to, and used by, an associated but separate subsidiary card account the use of which is independent from the account holder's credit card account. Advantageously, this rewards system provides an account holder with the benefit of cash-convertible points while providing a means for secure usage of that benefit by a designated individual (e.g. a child, or children, of the account holder).

A separate account number is established by the financial institution for the subsidiary credit card account (also referred to herein as the “rewards account”) and the credit limit of the subsidiary credit card account (and account number) is tied to the current balance of rewards points which have been accumulated through use of the account holder's account (also referred to herein as the “main account”). The subsidiary account holder (e.g. an authorized child of the account holder) is able to purchase merchandise such as books, music, software, video, games etc. by on-line shopping over the Internet using the subsidiary (rewards) account. Optionally, multiple subsidiary accounts may be established in like manner.

1. ODA Service

The operation of a preferred embodiment of the ODA system is explained in the following with reference to FIGS. 1-10 of the drawings. FIG. 1 is a top level view of the network system architecture for the ODA system. In the preferred embodiment, the account holder's personal computer (PC) 1 is connected with the Internet 2. Similarly, third party PCs 3 may be connected to the Internet 2. An account holder's wireless handset 4 and third parties' handsets 5 on a wireless network 6 are connected to the Internet 2 via a gateway 7 that bridges the wireless network 6 to the Internet 2. The Internet 2 is connected to servers 8, 9, and 10. Server 8 (oda.bankx.com) runs software modules of the ODA system. The communication between the user clients 1 and 4 as well as third party clients 3 and 5 to the server 8 is performed using conventional HTTP (Hyper Text Transfer Protocol) and HTTPS (HTTP using Secure Sockets Layer or Transport Level Security protocols) messages. For these messages a client device issues an HTTP request (using an HTTP URL(Uniform Resource Locator)) having the form: “http://oda.bankx.com/customer1?querydata=123−abc” and the server responds with a HTML, WML or other file for rendering on the client device whereby this file typically contains further URLs associated with hyperlinks for rendering on the client device. Within the HTTP URL the information before the “?” locates the server on the Internet and the user account within the server and the information after the “?” is used within that account to interact with the software and activate ODA functionality. Server 9 (smtp.ispx.com) is a local ISP mail transfer (sending) server and server 10 (pop3.ispx.com) is a local ISP customer mail server (receiving) that would be conventionally used by the account holder for email purposes. The ODA system links to servers 9 and 10 to provide enhanced email capabilities for the account holder.

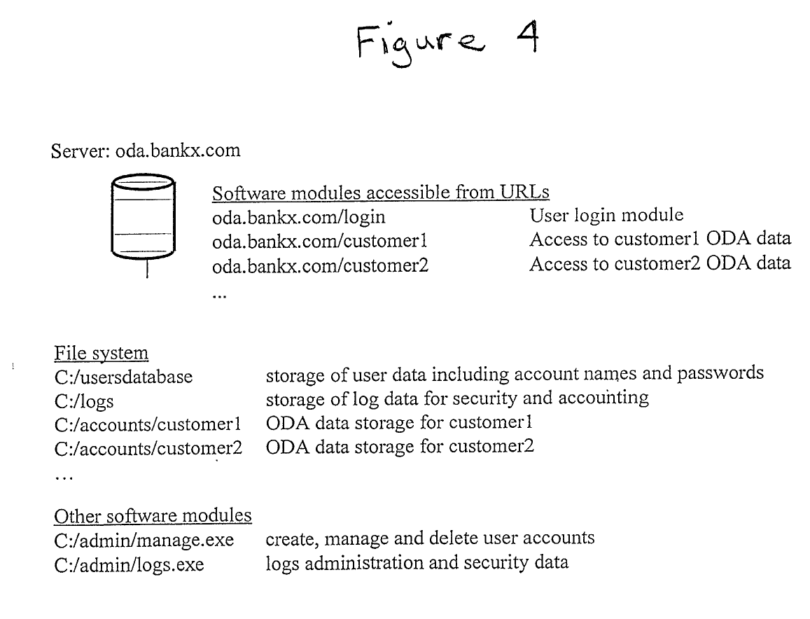

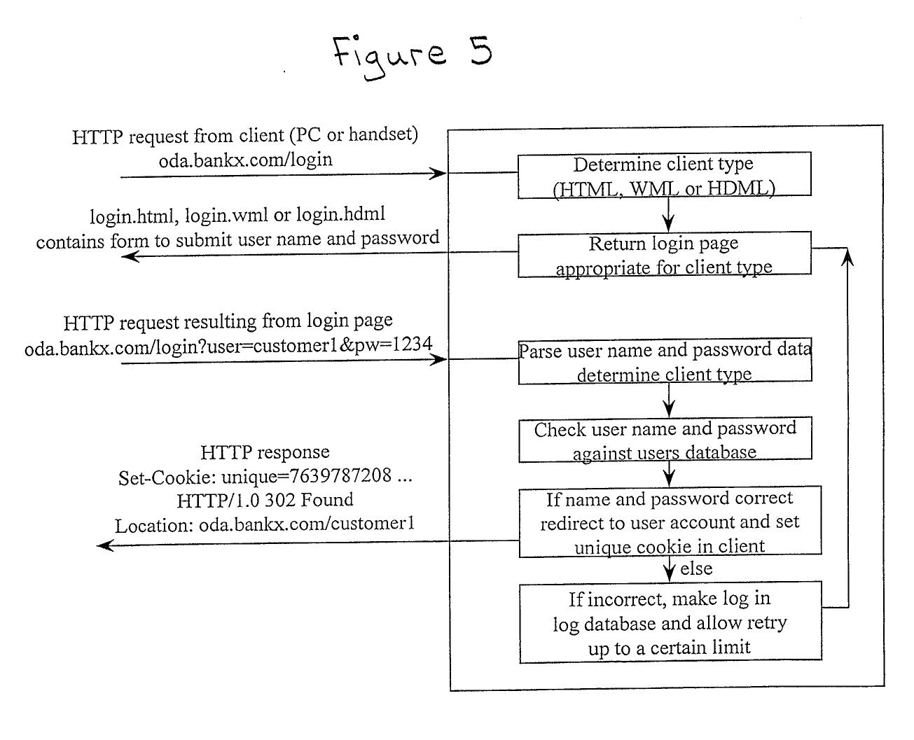

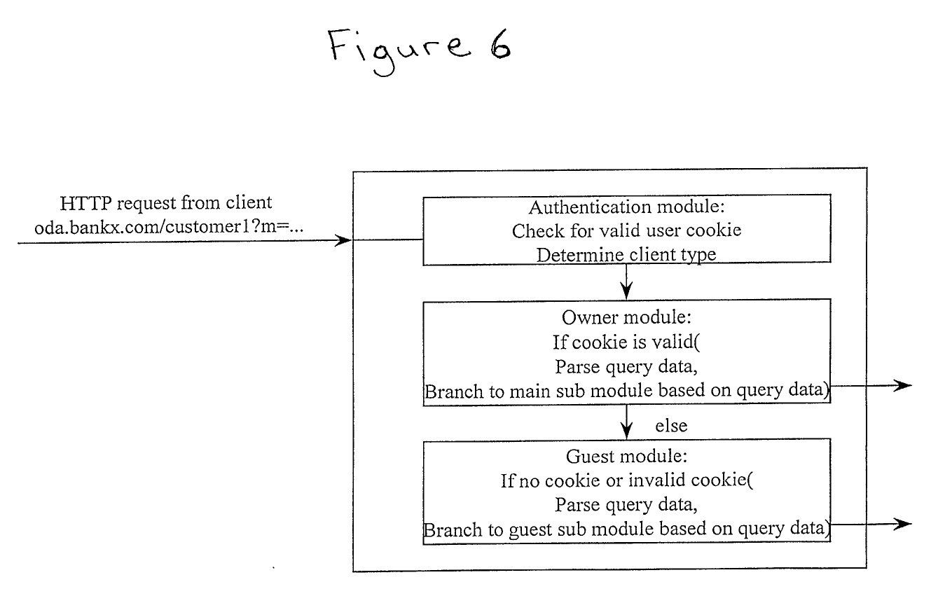

The ODA system software modules are outlined in FIG. 4. A user login module establishes an on-line communications link between the account holder and the account holder's assigned server storage space. Steps performed by the user login module are shown by the flow chart of FIG. 5. When the server 8 receives an HTTP request for logging in from an account holder's Internet access computer device (referred to as the “client” in the flow charts of the diagrams) the server 8 determines the client type (HTML, WML or HDML) and returns a login page, appropriate for the client type, which contains a form into which the account holder (also referred to as the user) submits a user name and password. This input data is then parsed and checked against a data base of users. If the submitted user name and password are verified from this check, a unique authorization message is included within a returned HTTP message (HTTP set-cookie) and sent to the user client. Once received, the client includes this authentication message (HTTP cookie) within all requests made to the ODA server in order for the server to authorize such requests. Otherwise, the login fails and the attempted login is recorded within a log event database and further login retries are allowed for a specific number of times set by the ODA software. Following this login, a user account software module performs the authentication steps shown in FIG. 6 to authenticate the user for that login session and any guest (i.e. third party) the user permits to participate in the session.

The ODA system is configured for the current generation mobile phone platform WAP/WML as well as the previous generation HDML, the cHTML language originally popularized in Japan, and the next generation XHTML Basic. Thus the currently popular Internet access computer devices, including mobile phones, RIM Blackberry™ and Palm VII™ etc. devices, are able to link to the ODA system without need to modify the device.

As stated, a unique passcode is assigned to each account holder (user) by the ODA system software which is required for connecting to the ODA system. The preferred embodiment uses the HTTPS/SSL/TLS/PKI security methods in the same manner as online banking systems. If desired, however, conventional password access could instead be used. The current generation of mobile phones are compatible with both of these security standards as are all modern Web browsers. The ODA system server 8 software activates the applied security standard.

To secure the centralized ODA data of the account holder, and maintain it as private as the account holder chooses, the ODA system software generates a random number temporary passcode for use by a third party authorized by the account holder to either access or deposit designated data into the account holders ODA server storage space. This temporary passcode is required for use by a third party in order to share information within the ODA as between the user and such third party. The temporary password is preferably time-limited (viz. 10 minutes in the preferred embodiment) such that when the time limit has elapsed the passcode expires and cannot be successfully used to gain access to the account holder's ODA. The user may, optionally, individually set an expire time for any shared time.

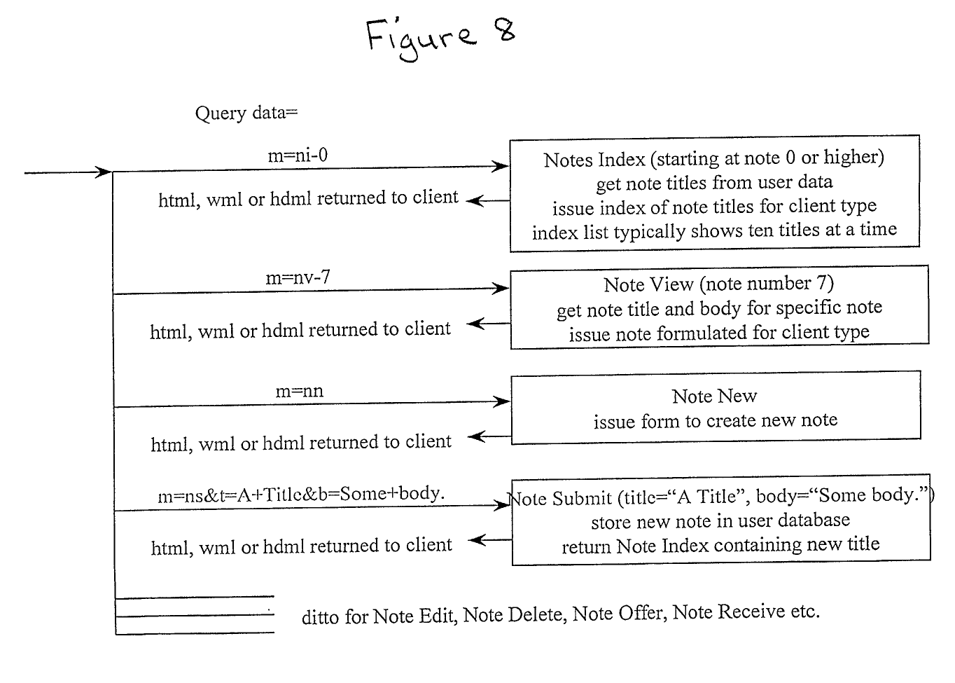

Various features of the service performed by the ODA system software are detailed in the following with a visual focus taken from the account holder's perspective (as per the mobile phone displays shown in FIGS. 2 and 3, as well as FIG. 9).

In the preferred embodiment a main menu software module provides the account holder a main menu, an example of which is shown below, once a successful login has occurred (the same menu being provided whether ODA access is by a mobile phone or conventional PC):

Messages-3 new

Schedule-2 today

Contacts

Bookmarks

Notes

Files

(eMoney)

Go to . . .

Options

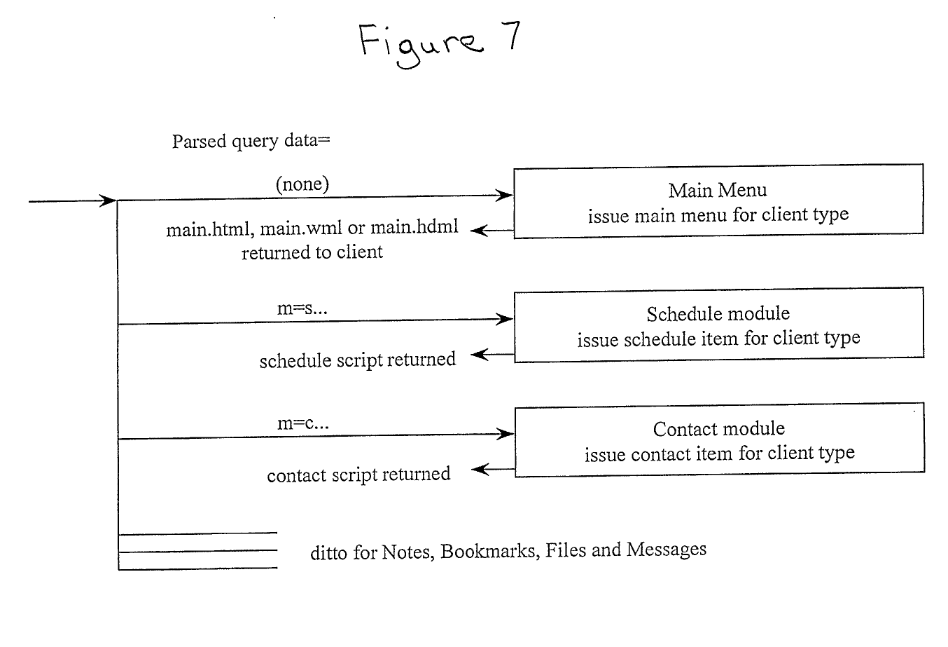

The steps performed by the main menu module software are shown by the flow chart of FIG. 7. When no user query data is present in a query field monitored by the ODA software, a main menu display (matching the established client type) is returned to client. Then, depending upon the parsed query data (as appended to the HTTP URL request in the Query field “m” or in the Post field of the HTTP message) received from the user, one of several user-selectable ODA software modules is operated. For example, if the user has selected the “schedule” menu item the returned parsed query data (m) is equal to s and a schedule software module is operated. If the user selects the “contacts” menu item the query data (m) is equal to c and a contacts software module is operated. Each of the menu items is a hyperlink to a separate ODA software module and, thus, the user is able to easily move between components of the ODA. The flowchart of FIG. 8 shows steps performed by the “notes” menu item software module and the steps performed by the other menu item software modules are similar. As shown by FIG. 8, the query data m=ni−0 is input first to return to the client a notes index from which the user may select from various menu and command options as shown in FIG. 9. For example, if the user selects an itemized note the query data m=nv−7 is received by the notes software module and, in response, the software module forwards that note page (for note id 7 comprising a title and body of text) to the user for viewing. If the user selects the command option “new” the query data m=nn is received by the software module and, in response, a form to create a new note is forwarded to the user for data entry.

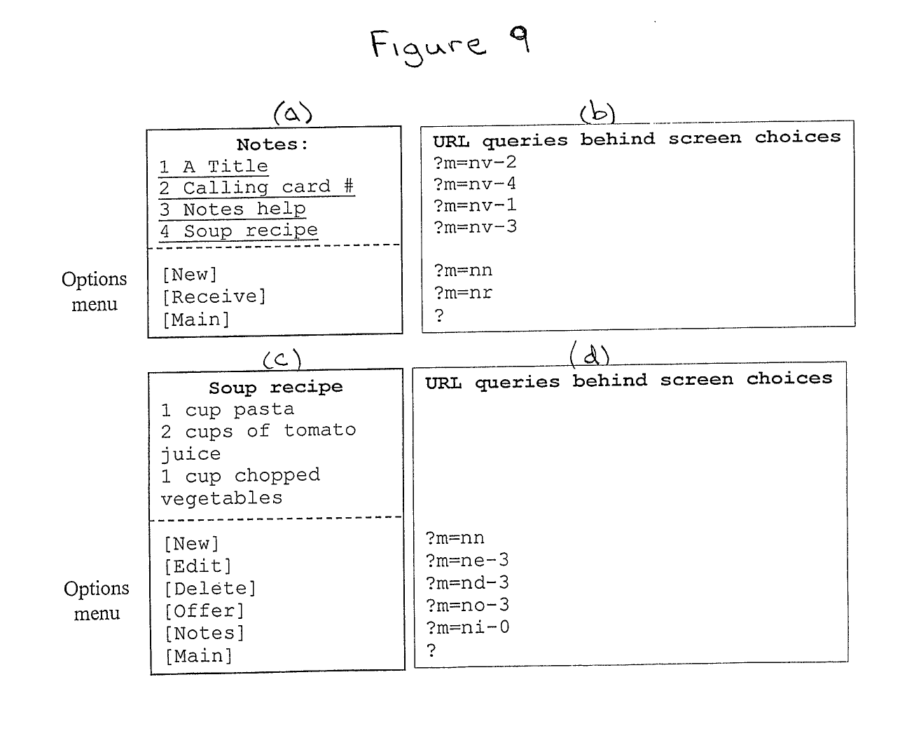

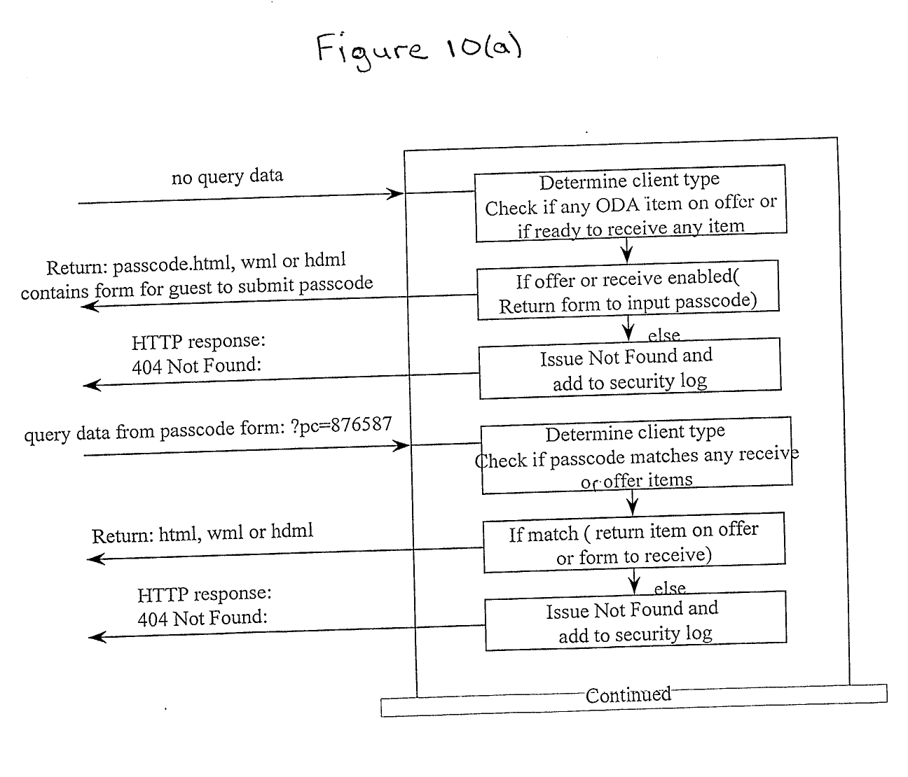

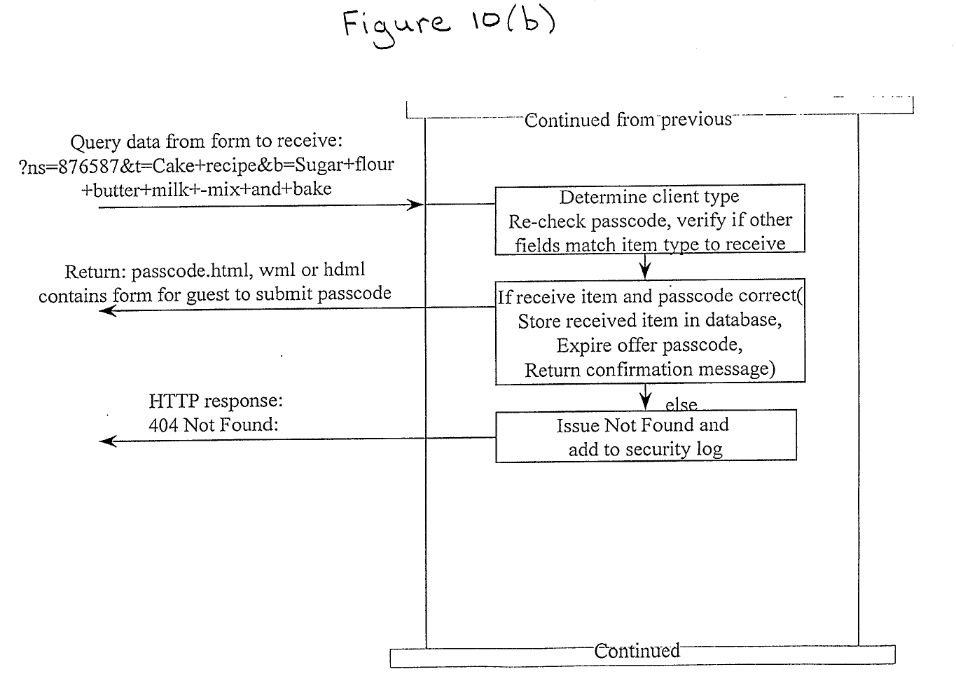

The ODA system software further includes a guest software module which performs the steps shown in the flowcharts of FIGS. 10(a), (b) and (c). This software processes user commands requesting either an “offer” or “receive” transaction. An “offer” is for sending ODA data to a third party whereas a “receive” is for receiving data from a third party for saving in the user's ODA storage space. An “offer” command can be issued for individual items within the ODA such as a note, an appointment, a contact, a file, etc. A “receive” command can be issued for component types such as to receive a note, appointment, contact, file, etc. from some other source. For each such command received from the user the ODA system generates a temporary password as described above which is associated either with the item or component type and displayed to the user. The user is then able to convey that temporary password to third party with whom the user wishes to share the specified data. Using an Internet access computer device the third party accesses the ODA system by means of the URL address for the user's ODA, whereupon the ODA offers a passcode entry form, and the third party enters the temporary password conveyed to the third party by the user. This password is received and verified by the guest software module and matched to the particular item or component module associated with that password. If the command is an “offer” of a specified data item, the data is returned to the third party. If the command is a “receive”, a form to receive data is returned to the third party. In the example provided by FIG. 10(b) a new note titled “cake recipe” is submitted by the third party. Optionally, as shown by the flow chart of FIG. 10(c), the ODA system may be programmed by the user to automatically accept messages from a specified third party ODA without need for a temporary password.

In the following a description is provided for each of the software modules associated with the main menu items in the preferred embodiment. These modules are selected via hyperlinks.

Messages

The messages function allows the account holder (user) to review emails from a mobile phone functioning as an Internet access computer device as well as to reply with pre-composed messages. In general, the user will likely wish to set up the auto-reply options using a conventional browser platform providing the convenience of a full screen, keyboard and mouse. Short auto-reply messages such as the following may be selected: Title: “Call me”; Body: “I am away from my PC right now but have seen your email on my mobile phone. Please call me at 514 555-1234.—J. Smith”. Other possible titles could include any of the following:

Appointment OK

Appointment conflict

Left a phone message

Go ahead with my approval

Go ahead without me

Please wait for my detailed reply

Here is the web address

Contact my colleague

Will reply in detail later

Please give me your phone number etc.

Once set-up this way, it is a simple manner to select an appropriate reply when reviewing e-mails on a mobile phone to allow the account holder to handle routine e-mails while away from a PC. Optionally, the ODA system may be programmed to enable the account holder to forward received e-mails to person(s) selected from the ODA Contacts list.

Schedule

The Schedule software module allows the account holder to create, review, share and receive appointments, birthday and holiday items. The user is able to easily review and create appointments on a mobile phone without need for a conventional browser and PC. If the appointment is a meeting with someone within the user's Contacts list, the person's name can be pulled from there without need for the user to enter such text through a mobile phone.

The flexibility provided by the present ODA system allows the creation of an appointment on a conventional PC and a viewing it by those authorized to receive it on either their mobile phones or PCs, whichever they choose. And, unlike conventional email, for which anyone who knows your email address can send you a message, the ODA system only allows an appointment to be received if the account holder has authorized such receipt (either by a temporary password or an automatic authorization as per FIGS. 10(a)-(c)).

An example of a possible use of the Schedule function of the ODA system is that the account holder may wish to allow an employee of a dentist's office to transfer an appointment to the ODA to avoid entering the details of the appointment by means of the account holder's mobile phone. To do so, the account holder would simply activate a temporary passcode to allow the authorized employee (i.e. the person to whom the passcode is given) to open up his/her Schedule for input of the appointment using the employee's full PC set-up (i.e. full screen, keyboard and mouse). Similarly, use of a temporary passcode and a couple of key presses will allow an authorized person on the Internet to review the details of an appointment.

An appointment may contain hyperlinks to permit easy access to webcast conferences or personal/business web sites etc.

Contacts

The Contacts software module of the ODA system allows a user to create review, share and receive contact information. If desired, the contacts information may be entered by the account holder using a PC with a conventional browser. Once entered, this information can be accessed at anytime through a mobile phone. When reviewing a contact in the ODA system by means of mobile phone access, the user is able to select one of the phone numbers of record to automatically dial that number on the phone, select a hyperlink to connect to that contact's ODA or web page or to send an email. The user is also able to share his/her own contact information to provide a electronic business card which can be provided anywhere on the Internet. An advantage provided by the ODA system is that even if the user's ODA address (i.e. URL) is widely shared, the knowledge of this address does not allow anyone to send a message or otherwise interact with a user's ODA unless that user specifically permits it by issuing a temporary passcode (or setting up an automated offer or receive acceptance sequence).

Should one ODA user wish to share a contact, appointment or other item with another ODA user using a mobile phone, this is done by means of just a couple of key presses for each user-the one user sharing the item opens it up for sharing and the other person receiving it goes to his/her contacts list, navigates to the name of the user sharing the item and selects the ODA hyperlink as part of the contact information. With a passcode obtained from the user sharing the information, the information can then be viewed by the other user as though it is part of that user's own ODA and, optionally, if desired by that user a copy may be permanently placed into his/her ODA.

A contact may contain hyperlinks to permit easy access to webcast conferences or personal/business web sites etc.

Bookmarks

The Bookmarks software module of the ODA system enables the user to create, use, share (i.e. offer) and receive Web bookmarks for both wireless and conventional Web sites. Like the other modules, the user can create an initial list using his/her PC and use then use a mobile phone Internet access device for sharing and receiving bookmarks as well as for activating wireless Web sites.

Notes

The Notes software module of the ODA system enables a user to create, review, share (offer) and receive notes. The subject matter of individual Notes files may range from important information requiring security, such as passport numbers, to less important information requiring little or no security, such as reminders, a calorie table for food items, directions to the house of out-of-town friends, “To Do” lists etc. A note may contain hyperlinks, such that a retailer can pass on a “help” note to a purchaser/user for the particular item purchased, with hyperlinks for various levels of customer support, and include the product serial number etc.

Files

The Files software module of the ODA system enables a user to upload, share (offer) and manage general computer files. It is assumed that most such files, such as a PowerPoint presentation, would not be viewable or executable on the user's mobile phone but the phone can be used to allow the ODA to share and receive such files from others. Subject to the storage limit of a user's ODA, the user can upload to their ODA from a PC any of resumes, PowerPoint presentations, documents, photos, music etc. using a Web browser program. Once these files are stored in the ODA the user is able to manage them using a mobile phone. Using the ODA, the user can both share ODA-stored files with third parties and receive new files to their ODA storage from third parties (as per the “offer” and “receive” processes described above). For example, vehicle maintenance record files can be stored in the ODA storage and shared with a service center when the user's car is being serviced. When the service has been completed the service center can return to the user's ODA an updated vehicle maintenance record file (i.e. using the center's PC with a conventional browser). Similarly, photos of one's house can be shared with a home furnishing retailer to discuss decorating options. Numerous other examples of possible usage may be identified, such as: Two different ODA users can meet on the street and exchange photos of their kids using their mobile phones; A salesperson/user can store in their ODA price lists and marketing presentations so as to be able to spontaneously pass these on to a new contact at any time (without having to carry a laptop computer around); A doctor can provide a user with an electronic prescription, enabling the user then pass it on to his/her pharmacy (and then an electronic receipt could be received from the pharmacy and passed on to an insurance company for reimbursement) etc. Generally, for every information item that can be found in a conventional wallet or purse (or glove compartment, or kitchen drawer etc.) an electronic equivalent can be created and stored in a user's ODA storage. Once this has been done, a user need only press a few keys on a mobile phone to access the files containing such information items from anywhere and selectively and securely share them with a third party through an Internet access device.

e-Money

The e-Money software module of the ODA system is optional and is used in conjunction with the rewards points system invention described and claimed herein. This module is simply a placeholder providing the user convenient hyperlink access to his/her rewards points (see the description below). Optionally, it may also include hyperlinks to other accounts of the user.

Go to . . .

The “Go to” software module of the ODA system allows a user to simply and spontaneously navigate to new Web addresses. It is intended primarily for use on a mobile phone to make it easier to enter Web addresses using the phone. One method of simple navigation is to select from a list of templates such as:

1) www.*.com

2) www.*.ca

3) www.yahoo.ca/*

4) www.yahoo.ca/stocks?symbol=*

Once selected a form is provided such that a user can enter replacement text for the field designated by the star to access hyperlinks simply from a wireless phone. The user can pre-compose these templates from his/her PC (or phone) and access them later when needed.

Another convenient method is to utilize business or personal phone numbers to link to a Web address. The ENUM standard will permit this in the near future.

This module can also allow a user to link selected items in the ODA to a web site and vice versa. For example, when a user purchases a book as a gift for a friend from a Website: “www.bookshop.com”, the ODA can be enabled to add query data to the URL, such as “oda=www.bankz.com %2Fcustomer1”, to inform the Website of the user's ODA URL. With this, the Website and ODA can collaborate and allow the ODA to provide the Contacts information for the friend which is contained in ODA's storage rather than re-type the delivery address information etc. Equally, information from a Website can be received into the ODA for later access and use. International standards govern these interactions and most standards are expected to be based on the extended Mark-up Language (XML) developed by the World Wide Web Consortium (W3C) which is authority that maintains the HTML standard.

Options

The Options software module of the ODA system enables the user to setup account details such as changing passwords, emptying or recovering trash, performing back-ups, logging off (which clears the authorized HTTP cookie), etc.

The ODA software is modular in nature; if the business of a user already has its own calendar system, the user's ODA appointment/schedule information can be bypassed by substituting a hyperlink to the business' system. Similarly, the file access module can be ported to company network server facilities to provide useful applications to employees. For example, in many meetings presentations are shown to attendees using a computer connected to a projector and in such an environment an ODA user having on hand a mobile phone with Internet access is able to supply additional material (i.e. material in their ODA storage) to the meeting, for example a presentation, price list, contact information, web site bookmark, customer requirements list, email etc.

Optionally, the ODA service provided by the financial institution can be tiered to offer the biggest account user's (i.e. the biggest spenders in the case of a credit card) higher levels of service which may include assigning more storage space to the user's ODA or allowing sub-accounts for family members.

Although an ODA system can be used from conventional browsers and PCs, the use from mobile phone platforms provides the user with greater connectability (i.e. more flexibility and mobility) and ability to collaborate with third parties to share and/or receive information.

2. Subsidiary Account Governed by a Separate Credit Limit

For conventional credit card accounts, credit card information such as the card number, credit limit, current balance, rewards points balance and other account holder information (e.g. name, address, etc.), is stored in a secure database and this information is accessed at the time the card is used for a purchase. At the time a purchase approval request is issued by a retailer for the account, using the account number and the amount to be charged, the foregoing account information is accessed and the amount to be charged is checked against the current balance of the account and the credit limit. If the credit limit would be exceeded by adding the amount to be charged to the current balance the request for approval is refused. If it would not be exceeded the request for approval is granted and the approved amount to be charged is added to the current balance for the account. As well, the rewards points balance is incremented according to the particular rewards formula applicable to the account. The credit limit is determined by the financial institution on the basis of a credit risk assessment having regard to the account holder's income and cash flow as well as their assets and liabilities. Such a limitation invariably applies to the known credit card systems.

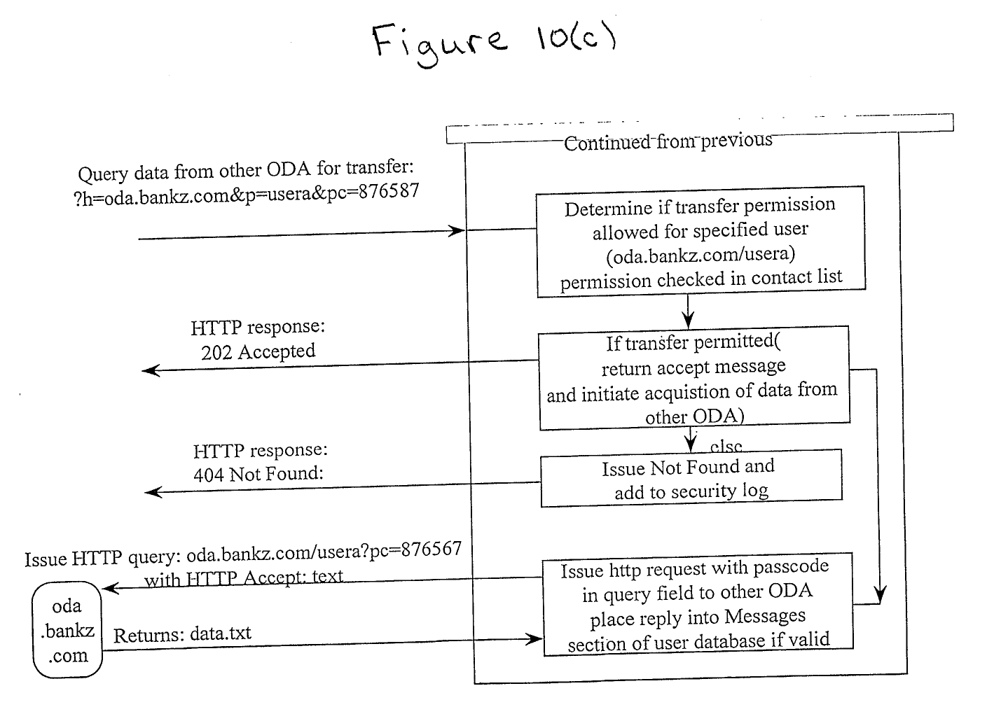

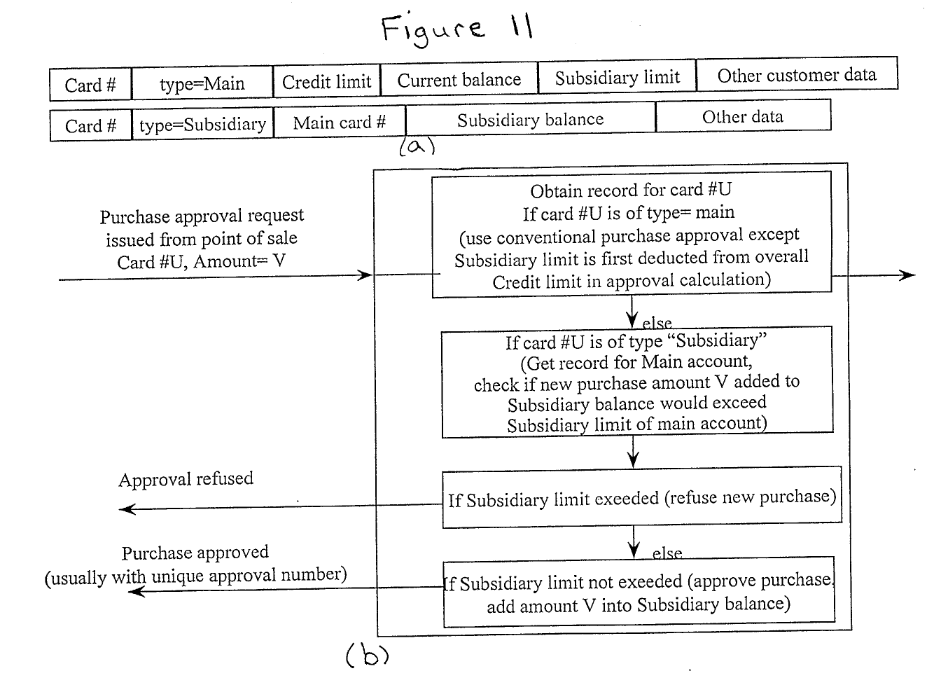

The applicant has developed a credit card management and authorization system which departs markedly from the known means for determining and applying a credit limit to a credit card. This system, which may be applied by a financial institution alone or in combination with the foregoing ODA service, provides a rewards benefit to a credit card account holder as illustrated by FIGS. 11(a) and 11(b). An account holder's credit card account is associated with a separate subsidiary card account the credit limit for which is controlled by the account holder (and is no greater than the credit limit of the account holder's credit card account). FIG. 11(a) illustrates a database structure for associating the account holder's account number and the subsidiary account number and accounting particulars relating to the credit limit governing each account. FIG. 11(b) is a flow chart of a purchase approval software module of the authorization system as applied to the subsidiary account (card).

The authorization software system may be configured to assign the credit limit to the subsidiary account on either a static or dynamic basis as desired. For example, a static assignment might be fixed at $20 or any other amount the account holder directs at the time the subsidiary account is set-up (so long as the amount is less than the credit limit applicable to the account holder's main credit card account to be associated with the subsidiary account). Then, each month as payments are made against the balance of the subsidiary account the assigned limit (e.g. the $20 limit) is effectively renewed. On the other hand, if a dynamic assignment of credit limit is selected, the holder of the main account is able to modify the assigned credit limit over the Internet or phone or through mailed instructions so as to adjust the limit, as desired, for the subsidiary account. Optionally, the foregoing account management and authorization system may extended to more than one subsidiary account associated with the main account.

It is to be noted that responsibility for payment of the subsidiary account lies with the account holder, not that person's authorized designee for the subsidiary account. Thus, when the accounts are reconciled on a periodic basis it is the account holder which provides payment for any purchases made on the subsidiary account by the authorized designee (or designees). Accordingly, the system provides the account holder with an effective means to provide a monthly allowance (e.g. having a $20 limit) to an authorized designee such as a child.

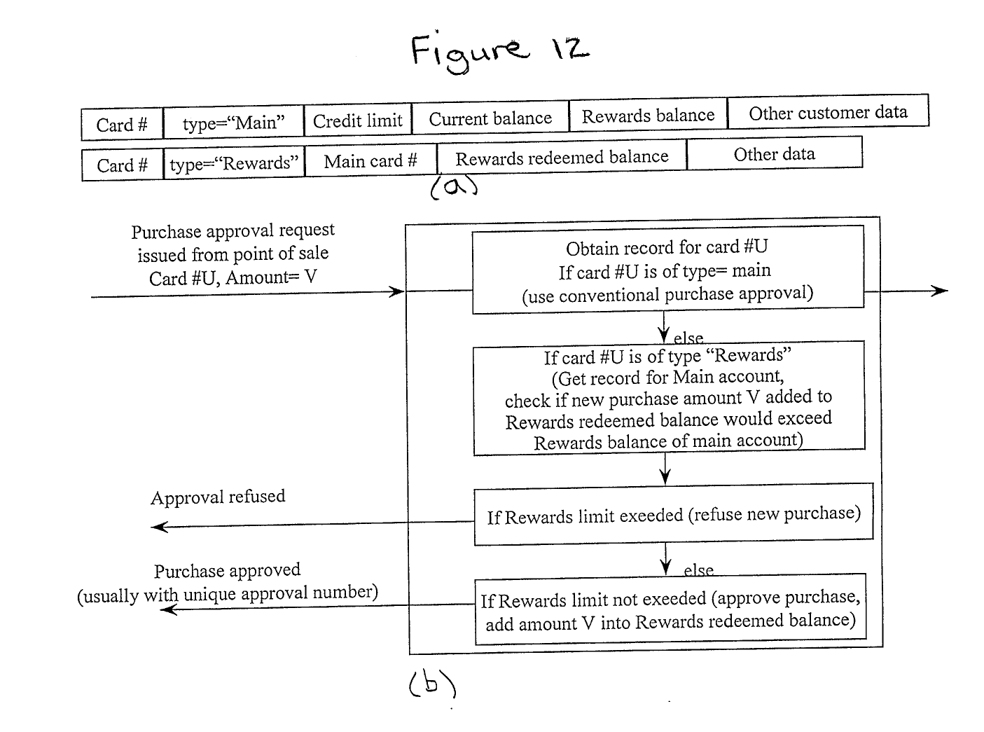

A further aspect of the foregoing account management and authorization system utilizes a points rewards benefit provided to an account holder, as illustrated by FIGS. 12(a) and (b). According to this aspect, points earned by a credit card account holder are attributed to a separate subsidiary (“rewards”) card account, the operation of which is independent from the account holder's credit card account. FIG. 12(a) of the drawings illustrates the database structure of a preferred embodiment of the points reward system. FIG. 12(b) is a flow chart of the steps performed by a purchase approval software module of the points rewards system, applied to a subsidiary credit card account which is associated with the account holder's account using the database structure of FIG. 12(a).

The rewards points system assigns reward points to a credit card account holder in response to usage of the account and attributes the benefit of the assigned points to a separate, associated subsidiary credit card account for conversion to cash value by an authorized designee of the account holder (e.g. a child of the account holder). The subsidiary account is assigned its own number separate from the account holder's main account number and has a usable credit value corresponding to the cash-convertible benefit of the attributed points. Thus, the authorized designee is able to make purchases (e.g. on-line purchases over the Internet) using the subsidiary account. It is to be noted that neither the designee nor main account holder must, necessarily, be provided with a physical credit card for the subsidiary account; rather, only the account number need be known as this can be communicated over the Internet to purchase merchandise using the subsidiary account. Optionally, a password may also be associated with this account to thwart fraud.

As shown by FIG. 12(a), for each “main” credit card account an additional “rewards” (subsidiary) account number is assigned to the main account and stored on a database in association with the main account and other credit card information pertaining both to the main and rewards accounts. The stored information for each main and rewards account pair includes: 1) For the main account, the card number, the type of account (i.e. main), the credit limit applicable to that account (i.e. to the account holder's card) as determined on the basis of the foregoing credit risk assessment factors, the current balance charged on the account, the rewards points balance (i.e. the number of accumulated points less the number of points which have been redeemed) and other customer data (e.g. name, address, purchase details, etc.); and, 2) For the rewards account, the card number (being a different number to the main account number), the type of account (i.e. rewards), the main card number with which this account is associated, the rewards points redeemed balance (being the number of points used since the last reconciliation has taken place between the rewards points balance of record for the associated main card and the rewards points redeemed balance for the rewards card), and other data (such as the name and relationship to the main account holder of the authorized user for the rewards card, etc.).

For cards which are determined to be for a main account, purchase authorizations are performed in the same manner as for conventional credit card systems as described above. For the rewards account, however, purchase authorizations are performed by the steps illustrated in FIG. 12(b). When the authorized user for the rewards account wishes to purchase an item, the rewards card number (U) and purchase amount (V) are forwarded to the card issuer's on-line authorization system with an approval request. Upon receiving the approval request the system checks the type of card (i.e. main or rewards account?) and if the number is for a rewards account the system determines whether the account number is currently associated with a valid main account. If it is the system accesses the account information for the main account associated with the rewards account and determines whether the requested purchase amount (V), when added to the rewards points redeemed balance for the rewards account, would exceed the rewards points balance for the main account. If it would, the purchase approval request is refused. If it wouldn't, the purchase approval request is granted and a unique approval number is assigned to the purchase authorization. In addition, the points value representing the approved purchase amount (V) is added to the rewards points redeemed balance for the rewards account (as well as storing other conventional details of the transaction).

Advantageously, the purchase activities which can be authorized for the rewards card are securely limited to the main card holder's accumulated points value, by attributing that value to the rewards account, while at the same time maintaining both the security and normal operation of the main card.

It is to be understood that the specific types, configurations and components of the embodiment described herein are not intended to limit the invention; for example, the invention is not intended to be limited to any specific configuration of the software modules, for which various alternative embodiments may be determined by one skilled in the art based upon the teachings herein and the particular application. The described embodiments are to be considered in all respects only as illustrative, and not restrictive. The scope of the invention, is therefore, defined by the appended claims, rather than by the foregoing description. All changes which come within the meaning and range of equivalency of the claims are to be embraced within their scope.

What is claimed is:

1. A method for providing a rewards benefit to a holder of an account, said method comprising:
(a) providing data storage space to said account holder in a data storage device, said storage space being accessed over the Internet through a central server running on-line digital assistant (ODA) system software configured for managing data in relation to said storage space;
(b) allocating an Internet address and passcode to said account holder, said address enabling Internet access to said central server and said passcode enabling access by said account holder to said storage space; and,
(c) enabling said account holder to use said ODA system software to store, access and process data in said storage space upon submission of said passcode.

2. A method according to claim 1 performed by a financial institution, whereby said account is a credit card account.

3. A method according to claim 2 whereby said data storage device is secured against access not authorized by said financial institution.

4. A method according to claim 3 and further comprising providing a temporary passcode to said account holder in response to a request for the same by said account holder, said temporary passcode enabling a third party to use said ODA system software to access or store data in said storage space upon submission of said temporary passcode by said third party.

5. A method according to claim 4 whereby said data includes electronic messages.

6. A method according to claim 5 whereby said data includes computer files.

7. A method according to claim 6 whereby said Internet access uses a Web browser running on an Internet access computer device.

8. A method according to claim 7 whereby said ODA system software causes a main menu of selectable data management operations to be displayed on a display of an Internet access computer device used by said account holder to access said ODA system software following submission thereto of said account holder's passcode.

9. A method according to claim 7 whereby said Internet access computer device is a mobile phone.

10. A method according to claim 7 whereby said Internet access computer device is a personal computer (PC).

11. A method for providing a benefit to a holder of a credit card account having associated therewith a credit limit, said method comprising:
(a) associating a separate, independently operable subsidiary credit card account with said credit card account;
(b) assigning a subsidiary credit limit to said subsidiary account; and,
(c) enabling an authorized designee of said credit card holder to effect charges against said subsidiary credit card account whereby the amount of said charges is limited by said subsidiary credit limit and any current balance of charges.

12. A method according to claim 11 whereby said subsidiary credit limit is assigned by said account holder.

13. A method for providing a rewards points benefit to a holder of an account whereby points are accumulated through usage of said account and said points are redeemable for value, said method comprising:
(a) associating a separate, independently operable subsidiary account with said account;
(b) attributing the value of said accumulated points to said subsidiary account; and,
(c) enabling an authorized designee of said account holder to use said value attributed to said subsidiary account through said subsidiary account.

14. A method according to claim 13 performed by a financial institution, whereby said account is a credit card account.

15. A method according to claim 14 whereby said points are redeemable for cash and said authorized designee is able to purchase merchandise through said subsidiary account, the value of said purchase being limited to the value of a current balance of said attributed points which have not yet been redeemed.

16. A computer network system operable through the Internet for providing a rewards benefit to a holder of an account, said system comprising:
(a) a central server having an allocated Internet address;
(b) a data storage device comprising data storage space and configured for access over the Internet through said central server; and,
(c) on-line digital assistant (ODA) system software running on said central server and configured for: (i) allocating data storage space of said data storage device to said account holder, (ii) managing data in relation to said storage space; (iii) permitting access to said central server using an Internet access computer device upon submission of said Internet address therefor; and, (iv) enabling said account holder to store, access and process data in said storage space upon submission of a passcode allocated to said account holder.

17. A computer network system according to claim 16 wherein said ODA system software is further configured for providing a temporary passcode to said account holder in response to a request for the same by said account holder and for enabling a third party to use said ODA system software to access or store data in said storage space upon submission of said temporary passcode by said third party.

18. A computer network system according to claim 17 wherein said data comprises electronic messages and computer files.

19. An account management and authorization software system operable on a computer processor to provide a rewards benefit to a credit card account holder, said software being configured for associating a separate, independently, operable subsidiary credit card account with said credit card account, assigning a subsidiary credit limit to said subsidiary account and authorizing a request for a charge against said subsidiary credit card account if the value of said requested charge is within said subsidiary credit limit less any current balance of charges.

20. An account management and authorization software system according to claim 19 wherein rewards points are accumulated through usage of said account holder's credit card and said points are redeemable for value, said software system being configured for establishing said subsidiary credit limit on the basis of the value of said accumulated points.
